(19) United States
(12) Patent Application Publication
(10) Pub. No.: US 2022/0314717 A1
(43) Pub. Date: Oct. 6, 2022

(54) CALIBRATED GAUGES FOR TIRE DEFLATORS TO SIMPLIFY THE SETTING OF TIRE PRESSURES AND IMPROVE THEIR ACCURACY

(71) Applicants: ARTHUR EDMUND SINGER, San Jose, CA (US); Edward Ray McMullin, Lodi, CA (US)

(72) Inventors: ARTHUR EDMUND SINGER, San Jose, CA (US); Edward Ray McMullin, Lodi, CA (US)

(21) Appl. No.: 17/713,222

(22) Filed: Apr. 4, 2022

Related U.S. Application Data
(60) Provisional application No. 63/169,873, filed on Apr. 2, 2021.

(51) Int. Cl. B60C 29/06

(52) U.S. Cl. CPC B60C 29/068; B60C 29/066

(57) ABSTRACT

The present invention relates to novel calibrated gauges for use with tire deflators which improve their ease of use, accuracy and consistency. Particularly, these novel gauges enable users to precisely set or maintain the distances between various fixed points on a tire deflator, which correspond to a desired tire pressure, enabling the simplified, precise and reliable setting of that tire deflator. This is a huge improvement as most tire deflators rely on inherently unreliable trial and error calibration of their air pressure settings which may change over time and without indication. More particularly, the present invention enables faster setting times for tire deflators with more reliable results, easier changes between pressure settings, and more accurate tire pressures. Embodiments of this invention include various gauges customized in dimension and material for use with different model tire deflators to achieve various tire pressures as desired.

### CROSS-REFERENCE TO RELATED APPLICATIONS

This application claims the benefit of provisional patent application Ser. No. 63/169,873, filed Apr. 2, 2021, by the present inventors, which is incorporated by reference in its entirety, except to the extent that the incorporated material is inconsistent with the express disclosure herein, in which case the language in this disclosure controls.

### BACKGROUND

The present invention relates to novel calibrated gauges for use with tire deflators which improve their ease of use, accuracy and consistency.

Many recreational, sports utility and 4×4 vehicles are designed to perform on a variety of on and off-road surfaces such as sand, gravel, mud, ice or snow and in a variety of weather conditions from desert heat to freezing temperatures where different tire pressures are required for performance and safety.

Current state of the art for quick tire pressure regulation is by means of a set of tire deflators. These tire deflators attach to the valves of tires. They allow for quick partial tire deflation to a preferred pressure. They come in sets of two or four so that multiple deflators can be used simultaneously to reduce the wait time while the front and rear pressure on a two or four wheeled vehicle is set. Each deflator is generally hand calibrated and set to achieve a desired partially deflated tire pressure for each tire or set of tires.

Most tire deflators require the rotation of a threaded adjustment cap to set the deflator to a desired tire deflation pressure while a locking nut is often used to retain that setting. Various methods may be used to determine and indicate the number of rotations of the cap needed to achieve a desired deflation pressure setting. However, the principal method for maintaining that setting is to move a locking nut just under the adjusting cap to secure that cap's position and thereby achieve or repeat a desired tire deflation pressure setting.

One drawback of the most popular current design is that the settings are not precise from one deflator to the next and cannot be determined by visual inspection. Pressure settings are generally made by referencing the current pressure and then counting the number of turns or rotations of the adjusting cap correlated to the desired pressure which is often inaccurate and needs to be verified manually. Pressure settings are often maintained by securing the adjusting cap in place by tightening a locking nut upwards against the cap from beneath. There may be visual marks on some models to aid in the counting of rotations as needed for setting desired pressures, but these methods are imprecise. These settings are often inconsistent from one tire deflator to the next within each set of two or four deflators. Furthermore, you cannot determine the current pressure setting for reference by means of visual inspection.

Another drawback is that the calibration of these deflators is highly susceptible to deviation either from the locking nut which tends to loosen with use allowing the adjustment cap to move up and down or as a result of deterioration of the deflator's internal spring's integrity from prolonged compression.

Therefore, a need exists in the field for a novel device to quickly and accurately calibrate and set these tire deflators with precise and repeatable results to enable a desired tire pressure setting which optimally is evident upon visual inspection. A further need exists to change these precise pressures quickly and easily when adjusting for use between different surfaces, weather conditions, or changes to the carrying, towing or overall weight of the vehicle.

### BRIEF SUMMARY OF THE INVENTION

This invention comprises a novel gauge or set of gauges for quickly determining, adjusting, setting, maintaining and visually confirming the desired pressure settings for tire deflators by means of gauging and dimensioning the space beneath the adjusting cap to another fixed point where a desired tire pressure is associated with each specific dimension. Each resulting pressure based on the dimension between two reference points on the deflator can be marked on a gauge allowing for the visual setting of a precise desired tire deflation pressure. One embodiment of the invention is a set of rings of various heights corresponding to the dimensions required to set desired deflator pressures, labelled to indicate the tire pressures they would set for each tire deflator when placed under the adjusting cap and tightened against the gauge preventing movement of the cap and relieving prolonged compression of the internal springs. Another embodiment of the invention is a gauge or set of gauges as described above but in the form of a C-clip with or without a handle which can remain in place during deflation or be removed without the need for disassembly or removal of the adjustment cap. Yet another embodiment of this invention is an external gauge or set of gauges to regulate, assess, or confirm the pressure setting on a tire deflator by gauging the position of its adjusting cap using fixed points of reference on the body of the tire deflator to reference the dimensions required to set the deflator to achieve a desired tire pressure. Preferred embodiments may vary based on the type and model of tire deflator being used in conjunction with current invention.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a flow chart representing the current trial and error process used with tire deflators to reduce tire pressure to a desired pressure.

FIG. 2 depicts a flow chart demonstrating the novel simplified process for achieving a precise desired tire pressure when using this gauge's proven relative measurements for setting or calibrating a tire deflator.

FIG. 3 depicts an exploded perspective view of one example of a currently standard tire deflator with the parts labelled as follows:
1 Adjusting Cap
2. Lock Nut
3. Spring
4. Plunger
5. Main Body

FIGS. 4 and 4A depict two side views of the common tire deflator set for different pressures.

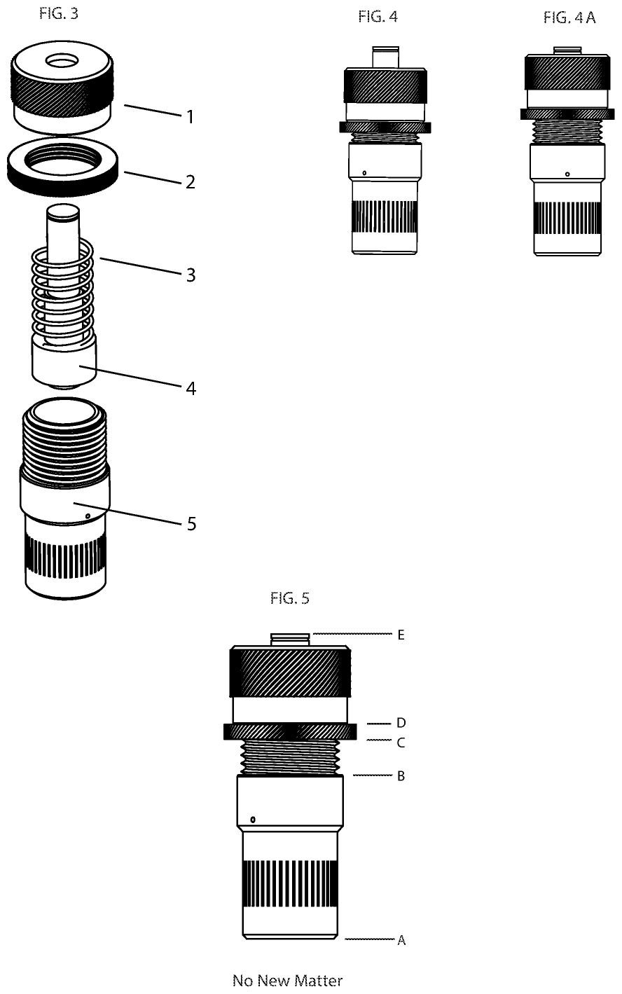

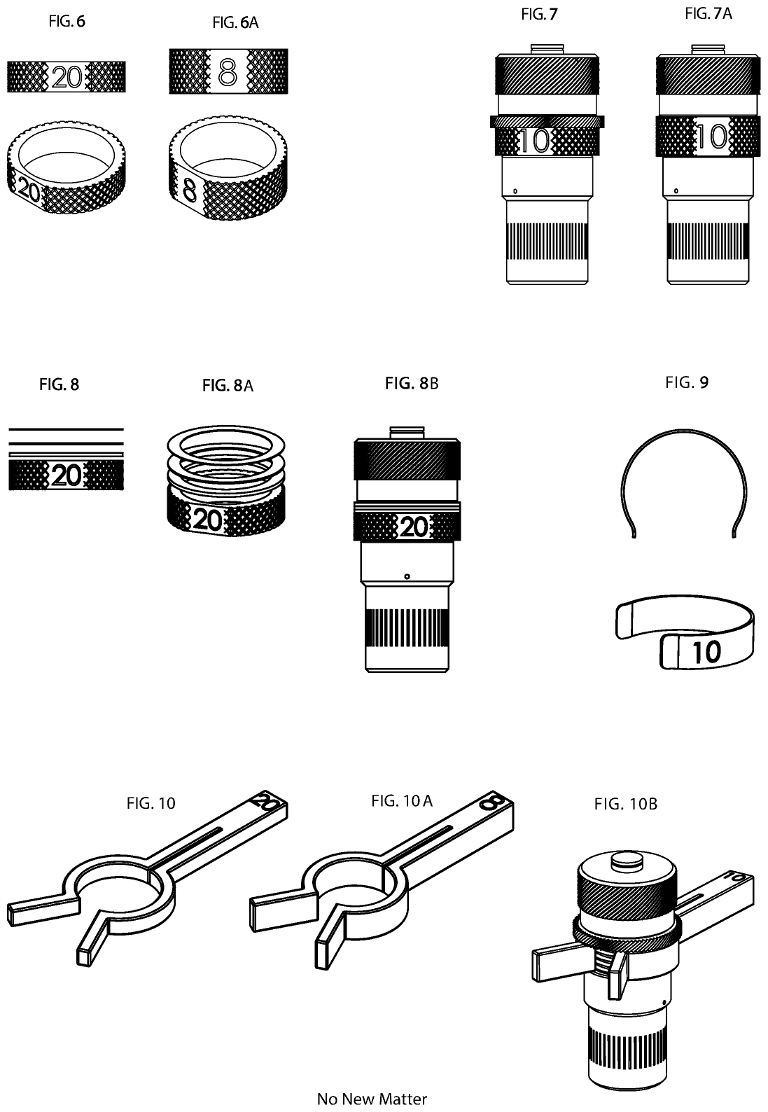

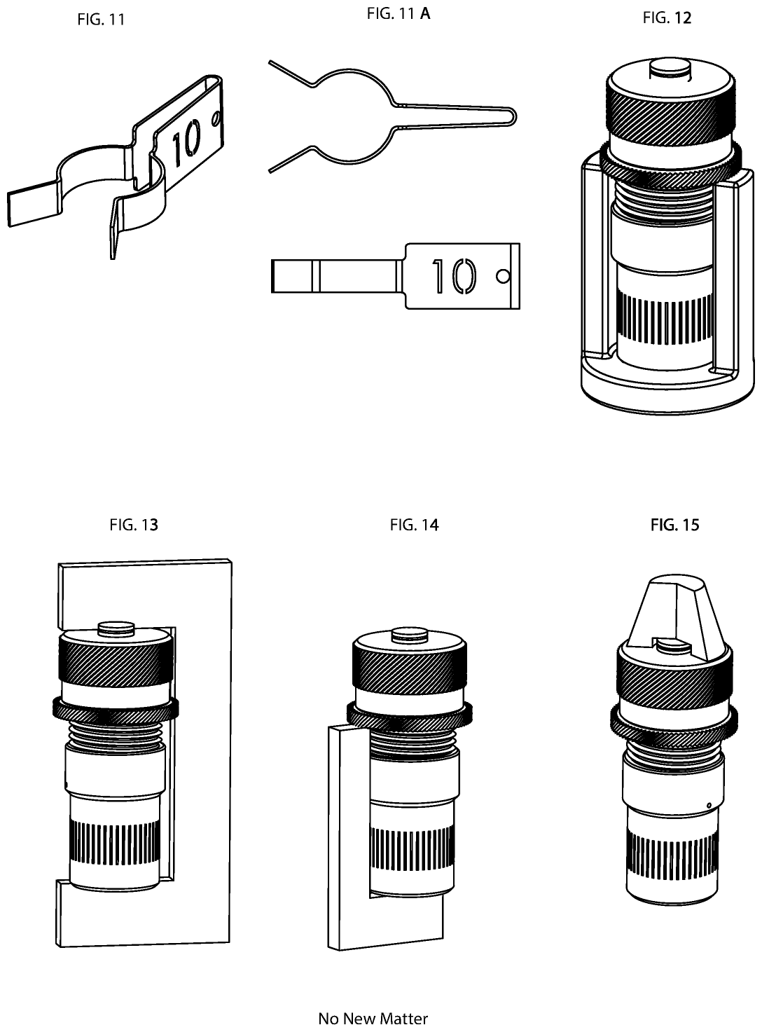

FIG. 4 depicts a common deflator set for a High Tire Pressure.
FIG. 4 depicts a common deflator set for a Low Tire Pressure.
Note: In FIG. 4 the plunger top is more visible and fewer threads are visible (higher pressure means a more compressed inner spring) and FIG. 4A has less plunger top visible and more threads visible (lower pressure means a less compressed inner spring).

FIG. 5 depicts different points of reference on the standard tire deflator set to a desired pressure with different dimensions between them, but which all correlate to the same desired pressure. These are examples of various points where different dimensions may be taken by our novel gauges to determine and set the deflator to achieve the same desired pressure.
A. Bottom of Main Base
B. Collar of Main Base
C. Lower Edge of Lock Nut
D. Lower Edge of Adjusting Nut
E. Top of Plunger

FIGS. 6 and 6A illustrate perspective views of one example of a novel calibrated gauging device according to various embodiments of the present invention. This embodiment as described in Claim 1 is a ring style embodiment of the deflator calibration gauge.

FIG. 6 Depicts a front and ¾ view of a 20 p.s.i. ring style deflator gauge. This embodiment of the ring deflator gauge is shown with exterior knurling and pressure indicator (numerical value related to the pressure that will be set) with a height calibrated to fit over a tire deflator and resulting in a tire to be deflated to 20 p.s.i. This gauge is placed around the tire deflator by first removing the adjusting cap and lock nut, the ring deflator is then placed over the threads of the main body to settle onto the lower collar of the deflator (Reference point B), the lock nut is not re-applied and the adjusting cap is tightened against the ring deflator gauge. The distance the locking nut occupies is taken into account when determining the height of the ring deflator gauge which represents a particular desired pressure.

FIG. 6A Depicts a front and ¾ view of an 8 p.s.i. ring style deflator gauge. This embodiment of the ring deflator gauge is shown with exterior knurling and pressure indicator (numerical value related to the pressure that will be set) with a height calibrated to fit over a tire deflator and resulting in a tire to be deflated to 8 p.s.i. This gauge is placed around the tire deflator by first removing the adjusting cap and lock nut, the ring deflator is then placed over the threads of the main body to settle onto the lower collar of the deflator (Reference point B), the lock nut is not re-applied and the adjusting cap is tightened down to the ring deflator gauge. The distance the locking nut occupies is taken into account when determining the height of the ring deflator gauge which represents a particular desired pressure.

FIGS. 7 and 7A show two side profiles of ring style deflator gauges with and without locking nut.

FIG. 7 Depicts a ring style deflator gauge, made to achieve deflation at 10 p.s.i. with the locking nut in place.

FIG. 7A Depicts a ring style deflator gauge, made to achieve deflation at 10 p.s.i. without locking nut in place.

FIGS. 8, 8A and 8B depict two exploded perspective views and a side view of one example of a gauge in the ring style with additional shims to modify the gauge to work accurately on various model deflators or in different situations e.g. with or without a locking nut according to the various embodiments of the present invention.

FIG. 8 Depicts a modified ring and shim style deflator gauge, front view for 20 p.s.i.

FIG. 8A Depicts a modified ring and shim style deflator gauge, ¾ view for 20 p.s.i.

FIG. 8B Depicts a ring and shim style deflator gauge for 20 p.s.i. in place with several shim gauges to set the deflator to achieve a lower pressure (longer, taller between reference points B to C, and without the lock nut.)

FIG. 9 depicts a top and ¾ side view of one embodiment of a C shaped clip-on spring style deflator gauges as described in Claim 1 and further described in Claim 2 and according to various embodiments of the present invention. This type of gauge can be applied without removing the locking ring or the adjusting cap expanding the distance from reference point B to reference point C (See FIG. 5), then pushing the open end of the clip-on gauge over the threads of the deflator from the side, then the locking nut and/or the adjusting cap is brought down to the spring deflator as it moves the spring gauge down onto the collar reference point B (see FIG. 5) thereby setting the proper distance for the desired pressure. It can be left in place or removed during regular use.

FIGS. 10, 10A, and 10B illustrate two ¾ side views and one view of a use case of one embodiment of a Clip-on spring style deflator gauge with handles as described in Claim 1 and further described in Claim 2 and according to various embodiments of the present invention. This type of gauge can be applied without removing the locking nut or the adjusting cap when expanding the distance from reference point B to reference point C (See FIG. 5), then pushing the open end of the clip-on gauge over the threads of the deflator from the side and adjusting the locking ring and/or the adjusting cap down to the spring deflator as it moves the spring gauge down onto the collar reference point B (see FIG. 5) thereby setting the proper distance for the desired pressure. This embodiment of the present invention can be left in place or removed during deflation of the tire.

FIG. 10 Clip-on with handle style spring deflator gauge (higher pressure 20 p.s.i., noted by shorter height).

FIG. 10A Clip-on with handle style spring deflator gauge (lower pressure 8 p.s.i., noted by taller height).

FIG. 10B Depicts the clip-on deflator gauge in use, fitting snugly around the threads of the main body of the tire deflator.

FIGS. 11 and 11A depict various views of a metal embodiment of the clip-on with handle embodiment of the present invention.

FIG. 11 depicts a ¾ view of a metal spring clip-on style gauge embodiment of the present invention.

FIG. 11A depicts a top and side view of a metal spring clip-on style gauge embodiment of the present invention.

FIG. 12 depicts a side view of one embodiment of a calibrating style deflator gauge with a base and two side towers of a fixed height as described in Claim 1 and further described in Claim 3, also known as the “Twin Towers” style deflator gauge and according to various embodiments of the present invention. This type of gauge can be applied under the tire deflator while the cap and locking nut are secured down against the tower sides of the gauge resulting in the desired tire deflator pressure being set.

FIG. 13 depicts a side view of one embodiment of a calibrating style deflator gauge as described in Claim 1 and further described in Claim 3 and according to various embodiments of the present invention, also known as the “Crab” style deflator gauge. This type of gauge can be applied over the top and bottom of the tire deflator and the cap and securing the locking nut to the top against the gauge will result in a desired tire deflator pressure being set.

FIG. 14 depicts a side view of one embodiment of a calibrating style deflator gauge as described in Claim 1 and further described in Claim 3 and according to various embodiments of the present invention, also known as the Square 90 Degree Angle style deflator gauge. This type of gauge can be applied against the bottom of a tire deflator and the cap and locking nut can be tightened down against the long side of the gauge resulting in a desired tire deflator pressure being set.

FIG. 15 depicts a side view of one embodiment of a calibrating style deflator gauge as described in Claim 1 and further described in Claim 3 and according to various embodiments of the present invention, known as the “Fez Hat” style embodiment of the present invention. This type of gauge can be applied to the top of the tire deflator over the plunger. The adjusting cap and lock nut can be tightened upward until the plunger touches the inside of the gauge and the gauge rests on top of the adjusting cap to allow the tire deflator's pressure to be accurately set.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, he singular forms “a,” “an,” and “the” are intended to include the plural forms as well as the singular forms, unless the context clearly indicates otherwise. It will be further understood that the terms “comprises,” and/or “comprising,” when used in this specification, specify the presence of stated features, steps, operations, elements, and/or components, and/or groups thereof.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, or the sake of clarity, this description will refrain from repeating every possible combination of the individual steps in an unnecessary fashion. Nevertheless, the specification and claims should be read with the understanding that such combinations are entirely within the scope of the invention and the claims.

New calibration gauges for use with tire deflators, devices designed to correlate dimensioning with desired tire pressure settings, apparatuses for gauging desired tire pressure settings, and methods for measuring and maintaining desired distances representing tire pressures on tire deflators are discussed herein. In the following description, for the purposes of explanation, numerous specific details are set forth in order to provide a thorough understanding of the present invention. It will be evident, however, to one skilled in the art that the present invention may be practiced without these specific details.

The present disclosure is to be considered as an exemplification(s) of the invention, and is not intended to limit the invention to the specific embodiments illustrated by the figures or description below.

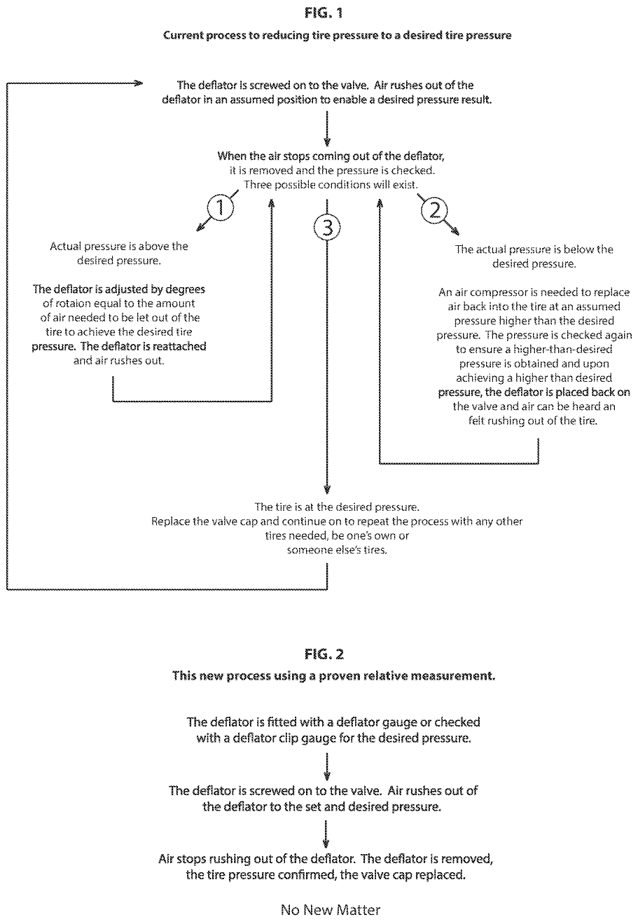

FIG. 1 describes the issues that the current trial and error process for setting tire deflators to a desired pressure is not precise or repeatable. Further in FIG. 3, to maintain a desired tire pressure, the position of the adjusting cap 1 and locking nut 2 must apply consistent and constant compression of the internal spring 3 responsible for the accuracy of the pressure desired. If the lock nut 2 loosens the referenced pressure that the deflator was set to is lost and the trial and error process must be repeated in order to reset the deflator to the desired and accurate tire pressure. If a different tire pressure is required, the trial and error process must be performed again to obtain the desired tire pressure. This requires significant time screwing them on, screwing them off, checking the pressure, letting more air out, putting more pressure in, then letting the pressure back down to a desired pressure, and finally rechecking the tire pressure. This trial and error process must be repeated for each tire deflator that needs to be re-calibrated. To keep the current setting of the deflator the adjusting cap 1 and lock ring 2 must maintain their position keeping the spring 3 in a compressed physical state when not in use affecting accuracy over time.

There are many styles and models of tire deflators which operate in this same manner. FIGS. 4 and 4A by turning an adjusting cap at the top of the deflator to change the amount of air that is released to a desired tire pressure in order to gain vehicle traction in different types of terrain such as snow, sand or mud. Staun, Coyote, and Rugged Ridge are a few of the most effective and popular tire deflators and are of similar construction, using similar pressure setting processes, and constructed of similar materials. FIGS. 3, 4, 4A and 5 show that the length of the adjusting cap relative to the main body of the deflator allows air to escape and determines the actual pressure visually by its overall axial length. There are no gauges attached to the deflator to determine the pressure after the deflator stops releasing air. The device must be removed and tire pressure checked for the actual pressure relative to the desired pressure with a separate tire pressure gauge.

Using FIG. 1's description one of three conditions will exist:

1) The actual tire pressure is the desired pressure.
The valve stem cap can be replaced and tightened and other tires can be checked.
2) The actual pressure in the tire is higher than the desired pressure.
The locking ring is loosened on the deflator and the adjusting cap is rotated in either a clock-wise or counter-clockwise manner that releases more air from the tire. The adjustment cap is rotated in increments of radial degrees in order for the deflator to achieve the desired tire pressure and the locking ring moved up against the adjusting cap and snugged up carefully as to not rotate the adjusting cap relative to the main body of the deflator. Doing so would alter the desired tire pressure. As an example, rotating the adjusting cap 90 degrees will raise or lower the tire pressure by one p.s.i. Therefore, if the actual tire pressure was reduced and measured at 15p.s.i., and the desired pressure is 12, then 270 degrees of rotation in the direction that will reduce tire pressure is required. The tire deflator is then replaced on to the valve stem of the tire, the air is released, the device stops when air rushing out of the deflator can no longer be heard or felt, and the tire pressure is then checked again.
3) The actual pressure in the tire is lower than the desired pressure. Air is replaced into the tire to higher that the desired pressure. The tire deflator lock ring is loosened, and the adjusting cap is rotated using a similar calculation process as in scenario #2, the locking ring tightened to the adjusting cap, and the deflator is replaced on to the valve stem of the tire, the air is released, the device stops when air rushing out of the deflator can no longer be heard or felt, and the tire pressure is checked again and repeated as necessary.

FIG. 5. The focus of the present invention in one embodiment is as a ring gauge (See FIGS. 6,7,8, to set and maintain the dimension between FIG. 5 reference point B (collar of main body) and reference points D (bottom of adjusting cap). Note that removal of locking nut will be made redundant in this ring style gauge embodiment of the present invention. FIGS. 7, 7A, and 8B show parallel top and bottom surfaces mating with their respective surfaces of the deflator and using the height/dimension between them to determine and consistently achieved the desired tire deflator pressure.

By discovering the distance from reference point B to reference point C in FIG. 5 of a tire deflator set for a higher pressure as seen in FIG. 4A compared to a tire deflator set for a lower pressure FIG. 4A each distance can be extrapolated into numerical values related to a tire pressure, e.g. pounds per square inch. For instance, the distance from a main body reference point FIG. 5 (A or B) dimensioned to a dynamic point (C, D, or E) in any combination equal the same desired deflated tire pressure. A to C, A to D, A to E, B to C, B to D, B to E will all have varying dimensions, yet will result in the same pressure.

The distance between reference points FIG. 5, A to E are always the same during the trial and error pressure setting process. While deflating a tire, the plunger will lengthen the overall dimension of the deflator allowing air to rush out while it is deflating. When the deflator has achieved its desired pressure, it retracts to its usual position. This is the only time the plunger extends. See also FIGS. 7 and 7A.

The higher the desired pressure the shorter the length between points A and D.
The lower the desired pressure the longer the length between points A and D.
Examples of Reference Points from FIG. 5:

### Reference Points Distance (D) Between Points (Millimeters, Mm) at Desired Pressure (p.s.i.)

| | mm@ | mm@ | mm @ | mm @ | mm@ |
|---|---|---|---|---|---|
| Reference Points | 20 p.s.i. | 15 p.s.i. | 12 p.s.i. | 10 p.s.i. | 8 p.s.i. |
| A to C | x | x + a | x + b | x + b + c | x + b + |
| | | | | | c + d |
| A to D | y | y + a | y + b | y + b + c | y + b + |
| | | | | | c + d |
| B to D (Principle | z | z + a | a + b | a + b + c | a + b + |
| focus dimension | | | | | c + d |
| points) | | | | | |

Solid Ring Gauges FIGS. 6 thru 7A, Modified Ring Gauges FIGS. 8, 8A, and 8B show clip-on gauges of various styles and with or without handles FIGS. 9-11A are some embodiments of the present invention as discussed in the Summary section of this application.

The embodiments of the present invention can be divided into two major categories:
1. Mounted or Secured Gauges: Embodiments of the invention that can be left on the deflator at all times for repeated uses at the same pressure. The ring gauges (FIGS. 6 and 6A1 can be left on continuously for ease of process. See also FIGS. 6, 6A, 7, 7A, 8, 8A, 8B and FIG. 9.
2. Removable Gauges: Embodiments of the invention that may removed from the deflator after setting. For single settings or to allow quick changes. See FIGS. 10, 10A, 10B, 11, 11A, 12, 13, 14, and 15.

There is a subset embodiment of the mounted and secured gauges which can function with or without the FIG. 3 described locking nut 2 left on the tire deflator during deflation. These gauges will of necessity vary in height to account for the locking nut remaining on the deflator during use or not. The height of the mounted or secured gauges is adjusted to either situation. It is however recommended that the locking nut remain for most removable gauge embodiments of the present invention to secure and retain the desired pressure set by those embodiments of the present invention.

The various embodiments of the present invention described here may be used in a series of gauges each having a different dimension/height that is critical as it represents a particular pressure it achieves. The range of pressures consists of whatever the tire or vehicle manufacturer suggests. The ring style gauges can be mounted to the deflator and remain during use. FIG. 3. After use the adjusting cap 1 can be loosened to relieve compression on the internal spring, thereby extending the useful life of the spring 3. Resetting to the same exact pressure requires simply retightening the locking nut 2 to the ring gauge (if used), and/or the adjusting cap 1. If another pressure is required the adjusting nut 1 is removed, the current ring gauge is removed FIGS. 6 and 6A, then the ring gauge for the new desired pressure is put in place and the adjusting nut 1 is tightened against the gauge. FIG. 2 shows that there is no longer a need to enact the trial and error procedure and the tire pressure can be lowered as soon as the deflator is applied to the valve stem when the user properly notes the noise or the feel of the tire deflating has ceased.

The present invention will now be described by referencing the appended figures representing the preferred embodiments.

FIGS. 7 and 7A demonstrate the ring style embodiment used with or without a locking nut. The reference distance from FIG. 5 points B to C is the same in both 7 and 7A which results in the same pressure—10 p.s.i. as indicated on each of the ring deflator gauges. The FIG. 3 lock ring-2 present in FIG. 7 can remain and a gauge designed to match the dimension created by the locking nut removed in FIG. 7A can be used to create the proper dimension to deliver the same desired pressure of 10 p.s.i.

FIGS. 8, 8A, and 8B allow for more than a single ring per each pressure desired this Ring and Shim process retains the initial ring and adds shims to create any pressure the deflator can normally produce. For instance, a higher pressure ring (20 p.s.i.) deflator is the base for a single set of deflator gauges. A shim ring with a known height dimension will result is added to a base ring deflator gauge to achieve a longer, taller dimension resulting in a lower pressure (one base ring deflator gauge, one shim deflator gauge). The shims can be of different dimensions (thickness) such as 0.5 mm, 0.2 mm, and 0.1 mm and used singularly or in combination to achieve the desired pressure. This process can be repeated and another shim ring deflator is added for yet another lower pressure (one base ring deflator gauge, two shim deflator gauges) for example. Repeating this process gives yet another lower repeatable, accurate, known pressure. These gauges can remain on the deflator during deflation if desired.

FIG. 9 demonstrates a basic “C-Clip” gauge embodiment of the current invention.

To apply the C-Clip spring metal gauge the locking nut and adjusting cap must be turned to expose as much thread from the main body to allow the spring clip gauge to be applied and fit snugly around the threads above the collar of the main body (reference point B FIG. 5). The spring clip gauge can be pushed onto the threads of the main body collar and the locking nut and the adjusting cap can be turned to compress the gauge against the collar. Parallel surfaces on the flat top and bottom of the gauges represent the distance between the two are critical for an exact dimension around the circumference of the gauge for mating with reference point surfaces (reference point B to reference point C) that produce an accurate desired pressure. These gauges can remain on the tire deflator during deflation if desired.

Additional embodiments of the present invention are removable gauge types, FIGS. 10, 10A, 10B, 11, 11A, 12, 13, 14, and 15 are classified as removable. The FIG. 3 locking nut-2 is retained to hold the setting of the desired pressure and the gauges are dimensioned to deliver a desired known pressure.

FIGS. 10, 10A, and 10B are embodiments of the present invention that apply a clip-on spring gauge between FIG. 3 the lock nut-2 and adjusting cap-1 which must be turned to expose thread from the main body to allow the spring clip gauge to be applied and fit snugly. The spring clip gauge can have a handle for ease of application and removal. It is preferably made of plastic or other solid yet springy material which can be pushed towards the collar of the main body collar-5 and the locking nut-2 and the adjusting cap-1 can be turned to compress the gauge against the collar creating the critical distance required to achieve the desired pressure.

FIGS. 11, 11A, and 11B demonstrate embodiments of the present invention preferably made of a springy metal such as steel. The spring steel clip-on gauges possess the same attributes of 10, 10A, and 10B.

FIG. 12 demonstrates another removable embodiment of the present invention, the “Twin Towers” Deflator Gauge. It uses the dimension between FIG. 5 Reference points B and C to set a desired pressure. Two pillars or towers help keep the base square to get an accurate pressure. The bottom of the main base sits flush on the gauge, the locking nut touches the top of the towers and the adjusting nut is brought down to lock in the desired pressure.

FIG. 13 demonstrates another removable embodiment of the present invention, the “Crab” Deflator Gauge. It uses FIG. 5 reference points A and the top of the adjusting nut to derive a desired pressure.

FIG. 14 demonstrates another embodiment of the present invention, the Square 90 Degree Angle Gauge. It utilizes FIG. 5 reference points A and C to derive a desired pressure. Care is needed to balance reference point A to remain square on the gauge and meet reference point C properly to obtain an accurate desired pressure.

FIG. 15 demonstrates another embodiment of the invention, the “Fez Hat” Gauge.

It utilizes the dimensions between the top of the adjusting nut and FIG. 5 reference point E (the top of the plunger) to derive a spacing that correlates directly to a specific pressure. The less the stem of the plunger visible the lower the pressure, and the more of the stem of the plunger visible the higher the pressure that will be delivered by the deflator's action.

Preferred materials for all embodiments of the calibrating gauges are solid, firm, and of a low expansion co-efficient to keep consistency and accuracy high. Gauges may be cast, forged, molded, cut from existing materials or formed in other ways. Ring Style Gauge embodiments are preferably made of material that is solid such as higher density plastic or metal because parallel surfaces on the flat top and bottom of the gauges represent the distance between the two are critical for an exact dimension around the circumference of the gauge for mating with reference point surfaces to produce an accurate pressure. Plastic with a firm but flexible characteristic and spring steel are preferred for certain Clip-on style embodiments of the invention which clip on to the tire deflator and the material should be inherently flexible during the application and removal cycle of fitting the gauge to the deflator and must not deform during either application or removal. While preferred materials for certain embodiments are described here, the invention and its embodiments are not limited by those materials. Wood, plastics, rubber, foam, metals, ceramics, polycarbonate, metal alloys, aluminium, brass, and other materials may comprise some or all elements of the calibrating gauges in various embodiments of the present invention. Existing prototypes of each embodiment noted have been constructed with various materials.

Although the present invention has been illustrated and described herein with reference to the preferred embodiments and specific examples thereof, it will be readily apparent to those of ordinary skill in the art that other embodiments and examples may preform similar functions and/or achieve like results. All such equivalent embodiments and examples are within the spirit and scope of the present invention, are contemplated thereby, and are intended to be covered by the following claims.

1. A tight tolerance calibrated dimensioning gauge or set of gauges to determine and set the distance between two fixed points on various styles and models of tire deflators corresponding to a desired pressure and enabling the setting and adjusting of the desired maximum tire deflation pressure for that tire deflator comprising;
(a) spacing gauge(s) designed to measure the distance between two fixed points on a tire deflator.
(b) which can be placed on or over a tire deflator prior to tire deflation.
(c) having a rigid one piece or multipart body with parallel sides to measure and/or adjust and/or maintain the position of a deflator's pressure adjusting cap relative to a fixed point on the deflator.
(d) with predetermined small degrees of angulation to set or affect specific tire pressures associated with each position of the adjusting cap relative to another fixed point on the tire deflator.
(e) creating or indicating a precise spacing between the adjusting cap relative to another fixed point on the tire deflator to set or affect specific tire pressures.
(f) where these calibrated spacings have been previously determined to correspond to a specific tire pressure deflation setting for that type and model of tire deflator.
(g) a set of markings, textures and/or color codes on the dimensioning and callibration device associated with achieving each specific tire pressure.

2. The calibrated dimension gauging device of claim 1 further compromising a solid or partially open ring or set of rings with or without handles having parallel sides which can be placed externally over the aspect of a tire deflator beneath its adjusting cap with or without a locking nut in place.

3. The calibrated dimension gauging device of claim 1 further compromising a gauge having a solid body which can be held under, over or against the external aspect of the screw on tire deflator either beneath or above the cap to adjust or assess the spacing from any two points of reference where one is on the body of the tire deflator and the other on or relative to the cap to assess the spacing needed to set desired tire pressures.
